(19) United States
(12) Patent Application Publication
(10) Pub. No.: US 2024/0337555 A1
(43) Pub. Date: Oct. 10, 2024

(54) DEVICE FOR TESTING PACKAGING LEAKAGE USING DIFFERENCE IN PRESSURE AND DISTANCE

(71) Applicant: Defense Agency for Technology and Quality, Gyeongsangnam-do (KR)

(72) Inventors: Nam Rye LEE, Daejeon (KR); Young Woo LEE, Daejeon (KR)

(73) Assignee: Defense Agency for Technology and Quality, Gyeongsangnam-do (KR)

(21) Appl. No.: 18/627,511

(22) Filed: Apr. 5, 2024

(30) Foreign Application Priority Data
Apr. 5, 2023 (KR) 10-2023-0044473

(51) Int. Cl. G01M 3/32

(52) U.S. Cl. CPC G01M 3/3209

(57) ABSTRACT

The present invention relates to a device for testing packaging leakage using a difference in pressure and distance. The present invention provides a device for testing packaging leakage including a test vessel having a sealed internal space that accommodates a packaged product and having a plurality of compartments, a distance measurement sensor configured to measure a distance to the packaged product, a pressure measurement sensor configured to measure a pressure in the test vessel, a vacuum pump configured to form vacuum in the internal space of the test vessel, a solenoid valve configured to adjust a vacuum level of the test vessel, and a control box interworked with the distance measurement sensor, the pressure measurement sensor, the vacuum pump, and the solenoid valve.

### CROSS-REFERENCE TO RELATED APPLICATION

This application claims the benefit of priority of Korean Patent Application No. 10-2023-0044473, filed on Apr. 5, 2023, the contents of which are incorporated by reference as if fully set forth herein in their entirety.

### FIELD AND BACKGROUND OF THE INVENTION

### 1. Field of the Invention

The present invention relates to a device for testing packaging leakage, and more specifically, to a device for testing packaging leakage using a difference in pressure and distance.

### 2. Discussion of Related Art

Since permeable protective clothings include an inner layer impregnated with activated carbon, it is difficult to achieve the performance as protective clothings when air is introduced into a package due to packaging leakage. Therefore, as a result of chemical materials stockpile reliability program (CSRP), leaked products determined as A1 (conditional time limitation extension) products and B1 (reuse after maintenance) products are selected to be used for educational or training purposes.

Tensile strength, carbon tetrachloride adsorption performance, and chemical agent tests are performed on good products determined as a result of leakage test among 13 samples per lot, and the minimum number of samples (7 or more good samples among 13 samples after a leakage test) are secured to conduct the test after leakage is required, but a leakage test failure rate is quite high. The leakage test failure rates were 29.3% in 2020 and 34.4% in 2019.

A leakage tester currently in use uses hot water and pressurization and is a high-weight tester which is usable only in a laboratory. Therefore, when the number of good samples is less than 7 as a result of the leakage test, a visit to a military camp is required to receive additional samples.

In addition, when visiting the military camp to collect samples, since the samples are checked visually, whether microscopic pinholes are present may not be checked, and thus there are many cases of failure in the actual leak test in the laboratory, and in addition, there is an opinion difference with the military camp about a subject responsible for packaging damage.

To receive the additional samples and eliminate an argument with the military camp, it is necessary to develop a tester that may check whether there is a leakage at the military camp without affecting packaging.

The military camp also needs a leakage tester that may check whether there is a leakage at the military camp to immediately check whether packaging damage caused by training or the like occurs to identify damaged products and store good products to immediately prepare for chemical, biological, and radiological (CBR) warfare.

### SUMMARY OF THE INVENTION

The present invention is directed to providing a packaging leakage tester, which can minimize the number of visits to a military camp by performing a leakage test on site, serve to protect a human body in chemical, biological, and radiological (CBR) warfare, and be applied to any product affected by packaging.

The present invention provides a device for testing packaging leakage including a test vessel having a sealed internal space that accommodates a packaged product and having a plurality of compartments, a distance measurement sensor configured to measure a distance to the packaged product, a pressure measurement sensor configured to measure a pressure in the test vessel, a vacuum pump configured to form vacuum in the internal space of the test vessel, a solenoid valve configured to adjust a vacuum level of the test vessel, and a control box interworked with the distance measurement sensor, the pressure measurement sensor, the vacuum pump, and the solenoid valve.

The packaged product may include a CBR protective clothing, decontamination agents, decontamination kits, or food products inside a film or can.

The number of compartments may be in a range of 5 to 20.

The test vessel may accommodate one CBR protective clothing, 5 to 20 decontamination agents, 5 to 20 decontamination kits, or 5 to 20 food products.

The test vessel may include an upper vessel and a lower vessel having the plurality of compartments.

The upper vessel and the lower vessel may be fastened using a locking device or fastened in a sliding manner.

The distance measurement sensor may be installed on an upper end of the test vessel in each compartment.

The distance measurement sensor may be a laser sensor and may measure a change in distance depending on whether to leak in a vacuum state, and a failure may be marked when the distance is out of a reference distance.

One pressure measurement sensor may be installed in the control box.

The solenoid valve may be operated based on data measured by the pressure measurement sensor, and a result measured by the distance measurement sensor may be displayed on the control box.

The control box may include a liquid crystal display (LCD) touch panel, and a screen of the LCD touch panel may include at least one of: (1) a pressure and time setting and display window through which a pressure and time value for each test product are set and displayed on the screen, (2) a result display window which displays a test result value for each product placed in the test vessel, (3) a distance display window which displays a value being measured by the distance measurement sensor, (4) a selection value setting window through which a pressure required in a storage test procedure for each test product is set, (5) a temperature and humidity measurement result display window, and (6) a start button, a stop button, and a save button.

The test device according to the present invention may be a mobile or portable test device that allows measurement to be performed on site, a single sample and a plurality of samples to be measured simultaneously, a failure of each of the samples to be checked when leakage occurs, and is applied to sealed packaged products including CBR materials and food products.

In addition, the present invention may provide a method of testing packaging leakage using the above-described device for testing packaging leakage.

The method according to the present invention may include sealing the test vessel after putting a test target product into the test vessel, forming vacuum in the test vessel using the vacuum pump and adjusting the vacuum level by operating the solenoid valve based on data measured by the pressure measurement sensor, and checking whether to leak by displaying a result measured by a distance measurement sensor on the screen of the control box.

### BRIEF DESCRIPTION OF THE SEVERAL VIEWS OF THE DRAWINGS

FIG. 1 is a configuration diagram of a device for testing packaging leakage according to the present invention.

FIG. 2 is a configuration diagram of a test vessel according to the present invention.

FIG. 3 is a picture of the test vessel according to the present invention.

FIG. 4 is a picture of a lower vessel according to the present invention.

FIG. 5 is a configuration diagram of a distance measurement sensor according to the present invention.

FIG. 6 is a configuration diagram of a pressure measurement sensor according to the present invention.

FIG. 7 is a configuration diagram of a vacuum pump according to the present invention.

FIG. 8 is a picture of the vacuum pump according to the present invention.

FIG. 9 is a configuration diagram of a solenoid valve according to the present invention.

FIG. 10 is a configuration diagram of a control box according to the present invention.

FIG. 11 is a picture of the control box according to the present invention.

FIG. 12 is a screen configuration diagram of the control box according to the present invention.

### DESCRIPTION OF SPECIFIC EMBODIMENTS OF THE INVENTION

Hereinafter, the present invention will be described in detail with reference to the accompanying drawings.

The present invention relates to a test device and method for directly checking whether there is a leakage caused by packaging damage of sealed packaged products on site using a change in pressure and distance.

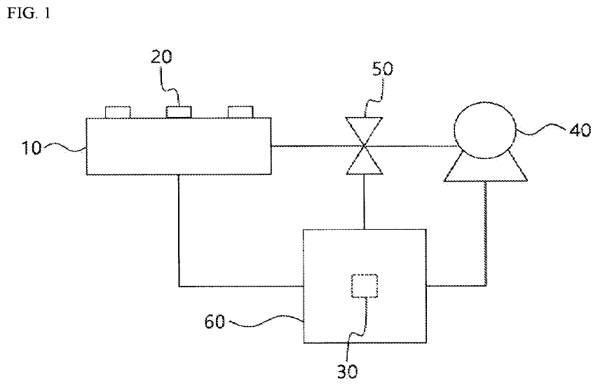

Referring to FIG. 1, a device for testing packaging leakage according to the present invention may include a test vessel 10, a distance measurement sensor 20, a pressure measurement sensor 30, a vacuum pump 40, a solenoid valve 50, a control box 60, and the like. One or more among the above-described components may be omitted as needed, and one or more other components may also be added to the above-described components. In addition, the above-described components may be connected through piping (pipes, tubes, or the like) and/or wiring (cables, wires, or the like).

The test vessel 10 serves to accommodate packaged products to be tested. The packaged products may include chemical, biological, and radiological (CBR) materials, for example, CBR protective clothings such as permeable protective clothings, decontamination agents, decontamination kits, and the like therein. In addition, the packaged products may include food products in addition to the CBR materials and may be applied to both film and can packaged products. Packaging materials may be in the form of a film or can, and may be formed of, for example, a 5-layer aluminum (Al) laminated film. Since the inside of the packaged product is filled with a predetermined amount of air to protect the CBR materials, food, or the like, the packaged product may maintain a certain degree of volume.

The test vessel 10 may have a shape, such as a hexahedron, and may be made of a metal or plastic. The test vessel 10 is sealed to have a sealed internal space to form a vacuum during a leakage test and may have a plurality of compartments partitioned by a plurality of partition walls. The number of compartments may be, for example, in the range of 5 to 20, 7 to 18, 9 to 16, or 10 to 14. Therefore, one test vessel 10 may accommodate one CBR protective clothing, 5 to 20 decontamination agents, 5 to 20 decontamination kits, or 5 to 20 food products. In addition, if necessary, for example, when the number of test objects is large, a set of test vessels may be formed by combining a plurality of test vessels 10.

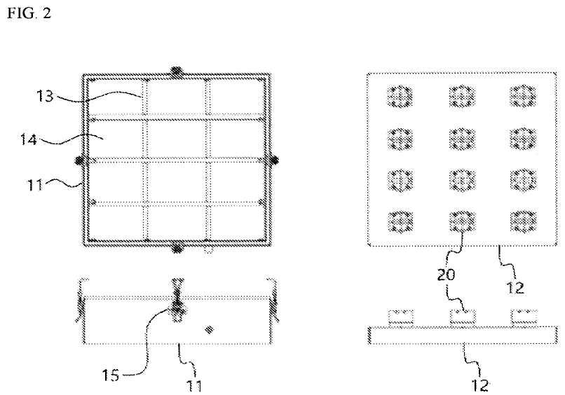

Referring to FIGS. 2 to 4, the test vessel 10 may include a lower vessel 11 and an upper vessel 12. The lower vessel 11 is a vessel body, has a sealed internal space, and may have a plurality of compartments 14 (e.g., between 5 and 20) partitioned by a plurality of partition walls 13. The plurality of partition walls 13 are formed in horizontal and vertical directions to form the plurality of compartments 14.

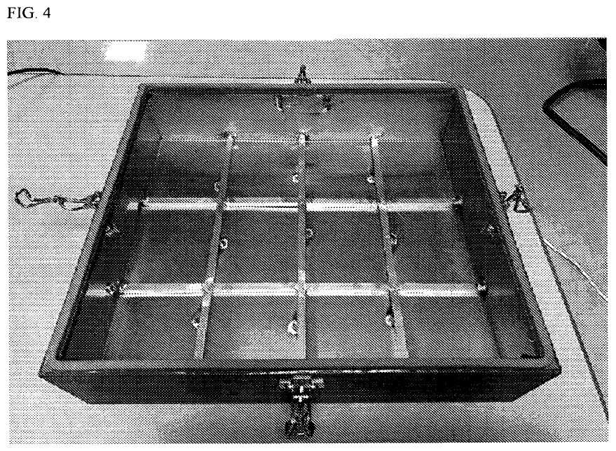

As shown in FIG. 4, a height of the partition wall 13 may be relatively low and may be formed low only at a lower portion of the internal space. One packaged product may be accommodated in one compartment 14, and in the case of large products, such as CBR protective clothings, one packaged product may be accommodated in the plurality of compartments 14. The compartments 14 may have, for example, a shape, such as a quadrangle, and have the same and appropriate sizes, for example, sizes suitable for the decontamination agent and the decontamination kit.

FIGS. 2 to 4 show an example of the test vessel 10 having 12 compartments, and thus one piece of CBR protective clothing and 12 DS-2 decontamination agents or 12 KD-1 decontamination kits may be put therein, and the test capacity may be increased depending on the number of test vessels.

Referring to FIGS. 2 to 4, the upper vessel 12 is a type of cover or lid, and a plurality of distance measurement sensors 20 may be installed on an upper surface of the upper vessel 12. At least one inlet and/or outlet, preferably, one inlet and/or outlet in each compartment, may be formed in the upper vessel 12, for example, at an installation portion of the distance measurement sensor 20 to suction, inject, and/or discharge air. The lower vessel 11 and the upper vessel 12 may be coupled and sealed to be opened and closed and may be, for example, fastened using a locking device 15 as shown in the drawing, and according to another embodiment, the two vessels 11 and 12 may be fastened in a sliding manner. For airtightness between the two vessels 11 and 12, at least one of the two vessels 11 and 12 may be provided with a sealing unit such as a rubber packing.

The locking device 15 may be installed, for example, on each of three side surfaces of each of the two vessels 11 and 12. The locking device 15 may fix the two vessels 11 and 12 through hook coupling, for example, as used for general vessels. The locking device 15 may include, for example, a hook ring, a lever, a fixing bracket, etc. A portion of the hook ring may be in the form of an inclined ring and may be coupled with a hook latch formed on one of the two vessels 11 and 12. The lever may be connected to the hook ring to make and release the hook coupling of the hook ring. A fixing bracket is fixed to one of the two vessels 11 and 12, and the hook ring and the lever may be rotatably fixed to the fixing bracket. When the hook ring moves upward near the hook latch, the lever also moves up, and then when the lever is pulled down, the hook ring and the hook latch are in close contact with each other to make the hook coupling. Conversely, the hook coupling may be released when the lever moves upward.

The distance measurement sensor 20 serves to measure a distance to the packaged product to check whether the packaged product leaks. The distance measurement sensor 20 may measure the distance between the packaged product and the sensor 20, and for example, when the size or shape of the packaged product changes depending on whether the packaged product leaks, the distance between the packaged product and the sensor 20 changes, and thus it is possible to check whether the packaged product leaks by measuring the distance. For example, a change in distance depending on whether the packaged product leaks may be measured in a vacuum state, and when the distance is out of a reference distance, a failure may be marked.

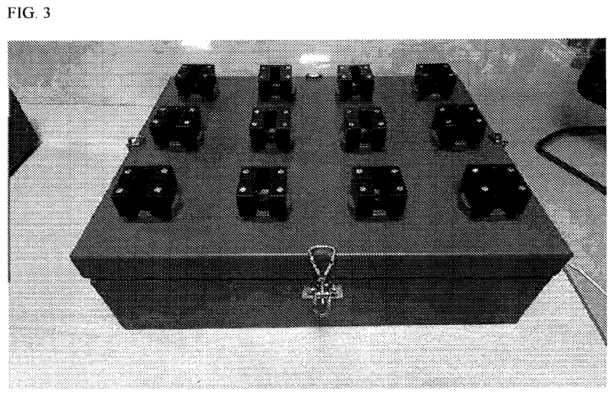

The distance measurement sensor 20 may be installed outside and/or inside the test vessel 10, and for example, one distance measurement sensor 20 may be installed on an upper end (upper surface) of the upper vessel 12 in each compartment 14 of the upper vessel 12 as shown in FIGS. 1 to 3. FIGS. 2 and 3 show an example in which a total of 12 distance measurement sensors 20 are installed one-to-one in 12 compartments 14. The distance measurement sensor 20 may be connected to the control box 60 through a cable or the like and interworked with the control box 60 to check whether the product leaks.

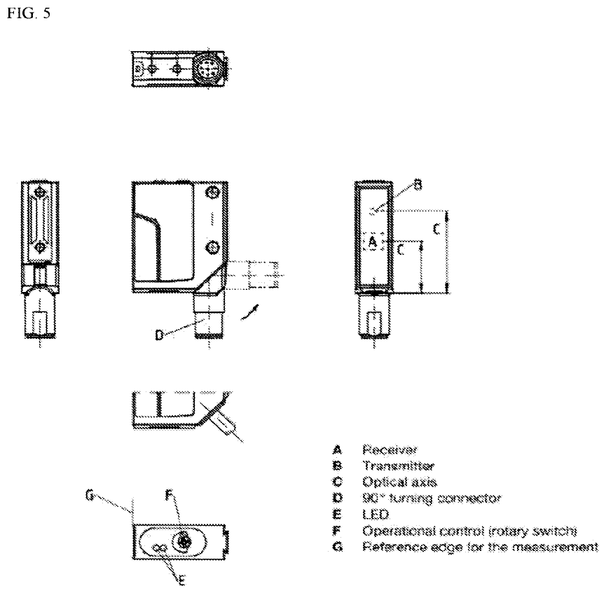

Referring to FIG. 5, the distance measurement sensor 20 may be a laser sensor, and specifically, may include a receiver, a transmitter, an optical axis, a 90° turning connector, a light source (light emitting diode (LED) or the like), an operational control, such as a rotary switch, a reference edge for the measurement, and the like.

Table 1 shows detailed specifications of the distance measurement sensor 20, in which the measurement range of the distance measurement sensor 20 may be 20 to 200 mm, the resolution may be in the range of 0.1 to 0.2 mm, the measurement accuracy may be ±2%, the measurement time may be in the range of 2 to 7 ms, the operating voltage may be in the range of DC 18 to 30 V, the output voltage may be in the range of 1 to 10 V, the output current may be in the range of 4 to 20 mA, the laser class may be class 2 according to the International Electro-technical Commission (IEC) 60825-1:2007, and the wavelength may be in the range of 650±30 nm.

TABLE 1

| Measurement range | 20-200 | mm |
|---|---|---|
| Resolution | 0.1-0.2 | mm |
| Absolute measurement accuracy | ±2% up to 200 mm | |
| Measurement time | 2-7 | ms |
| Operating voltage | 18-30 VDC | |
| Analog ouput | Voltage 1-10 V/current 4-20 mA | |
| Laser class | 2 acc to IEC 60828-1:2007 | |
| Wavelength | 650 | nm |
| Housing | metal | |
| Optics cover | glass | |
| Weight | 70 | g |

| | |
|---|---|
| Protection class | IP67, IP69K |
| Ambient temperature | −40° C.-+50° C. |

The pressure measurement sensor 30 serves to measure a pressure in the test vessel 10. For example, one pressure measurement sensor 30 may be installed in the control box 60 and alternatively, may be installed outside and/or inside the test vessel 10. The pressure measurement sensor 30 may be connected to the test vessel 10 through pipes and/or cables and may also be interworked with the control box 60. The solenoid valve 50 may be operated based on data measured by the pressure measurement sensor 30, and the results measured by the distance measurement sensor 20 may be displayed on the control box 60.

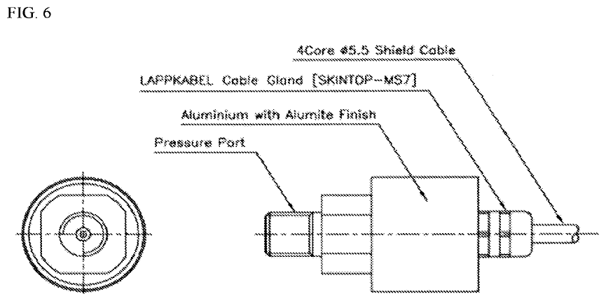

Referring to FIG. 6, the pressure measurement sensor 30 may include a pressure port, aluminum with alumite finish, a cable gland, a shield cable, and the like.

Table 2 shows detailed specifications of the pressure measurement sensor 30, in which the measurement range of the pressure measurement sensor 30 may be −100 to 300 kPa, the accuracy may be ±0.5%, the operating temperature range may be −20 to 80° C., the operating voltage may be in the range of DC 11 to 28 V, and the output current may be in the range of 4 to 20 mA.

TABLE 2

| Measurement range | −100 kPa-300 kPa | |
|---|---|---|
| Accuracy | ±5% | |
| Compensated temperature range | −10 ° C.-70° C. | |
| Operating temperature range | −20 ° C.-80° C. | |
| Operating voltage | 11-28 | VDC |
| Output | 4-20 | mA |

| | |
|---|---|
| Media-wetted materials | Stainless steel 304, |
| | Titanium 87%, O-ring: EPDM |
| Weight | Approx. 130 g |

The vacuum pump 40 serves to generate (provide) a vacuum pressure (negative air pressure) in the internal space of the test vessel 10. The negative pressure may indicate a pressure lower than atmospheric pressure (1 atm) and may generally be referred to as a vacuum. The vacuum pump 40 may be connected to the test vessel 10 through pipes or the like to suction air in the internal space of the test vessel 10 to generate the negative pressure (vacuum). As described above, the pipe may be connected to the upper end of the upper vessel 12 through a through hole formed in each compartment 14. In addition, the vacuum pump 40 may be interworked with the control box 60.

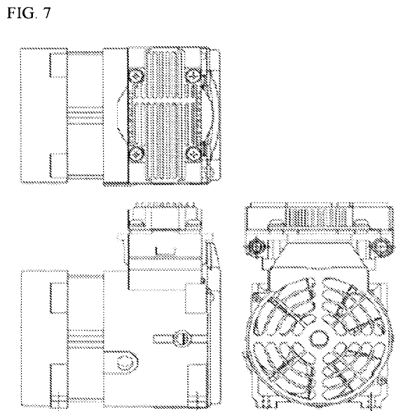

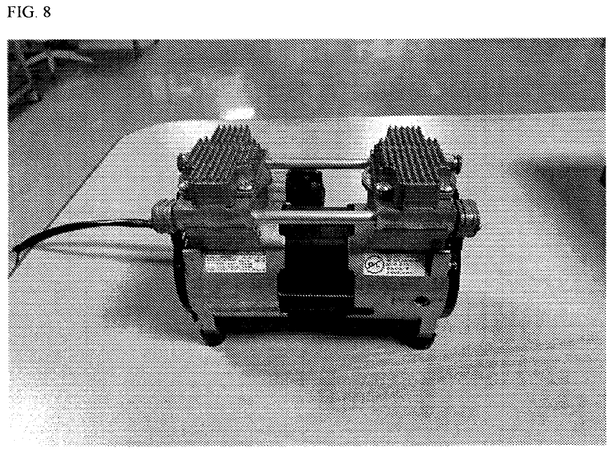

The type, specification, negative pressure, vacuum level, or the like of the vacuum pump 40 is not particularly limited and may be set appropriately. For example, a vacuum level may be appropriately selected from low vacuum (1 to 1000 mbar), medium vacuum (10⁻³ to 1 mbar), high vacuum (10⁻⁷ to 10⁻³ mbar), ultra-high vacuum (10⁻¹⁰ to 10⁻⁷ mbar), and extremely high vacuum (smaller than 10⁻¹⁰ mbar). FIGS. 7 and 8 show the vacuum pump 40 that may be used in the present invention, and Table 3 shows detailed specifications of the vacuum pump 40, in which the maximum pressure of the vacuum pump 40 may be 700 mmHg, the accuracy may be ±0.5%, the operating temperature range may be −20 to 80° C. the operating voltage may be in the range of DC 11 to 28 V, and the output current may be in the range of 4 to 20 mA.

TABLE 3

| Maximum pressure | 700 | mmHg |
|---|---|---|
| Accuracy | ±0.5% | |
| Compensated temperature range | −10 ° C.-70° C. | |
| Operating temperature range | −20 ° C.-80° C. | |
| Operating voltage | 11-28 | VDC |
| Output | 4-20 | mA |

| | |
|---|---|
| Media-wetted materials | Stainless steel 304, |
| | Titanium 87%, O-ring: EPDM |
| Weight | Approx. 7.5 kg |

The solenoid valve 50 serves to adjust the vacuum level of the test vessel. The solenoid valve 50 is an electronic valve that is opened and closed by a force of a magnetic field when electricity flows through a wire wound spirally. The solenoid valve 50 may be installed on the pipe for connecting the test vessel 10 with the vacuum pump 40 or the vacuum pump 40 and connected with the pressure measurement sensor 30 and the vacuum pump 40 and interworked with the control box 60, and thus the solenoid valve 50 may be operated based on the data measured by the pressure measurement sensor 30.

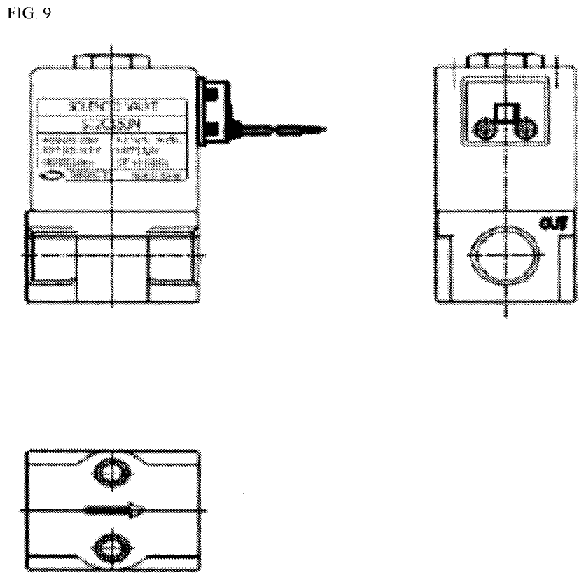

FIG. 9 shows the solenoid valve 50 that may be used in the present invention, and Table 4 shows detailed specifications of the solenoid valve 50, in which the fluid of the solenoid valve 50 may be air, water, and/or oil (viscosity of 50 cst or less), the pressure proof may be 25±3 bar, the operating temperature range may be 0 to 60° C., the response time may be 15±2 ms upon turning on and 20±2 ms upon turning off, and the operating voltage may be AC 220±20 V (60±5 Hz).

TABLE 4

| | |
|---|---|
| Fluid | Air, water, oil(under 50 cst) |
| Pressure proof | 25 bar |
| Operating temperature range | −0 ° C.-60° C. |
| Response time | On: 15 ms/Off: 20 ms |
| Operating voltage | 220 VAC (60 Hz) |
| Protection class | IP65 |

The control box 60 is a controller and connected and interworked with the test vessel 10, the distance measurement sensor 20, the pressure measurement sensor 30, the vacuum pump 40, and the solenoid valve 50 and thus may serve to control the components and output and display result values. The control box 60 may operate the solenoid valve 50 based on the data measured by the pressure measurement sensor 30 and display the results measured by the distance measurement sensor 20 on a light crystal display (LCD) touch panel.

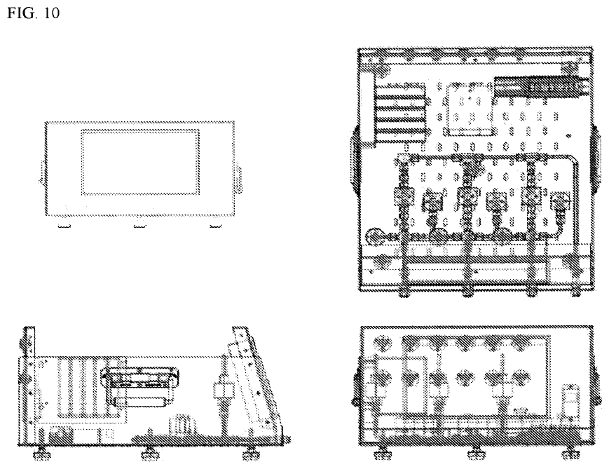

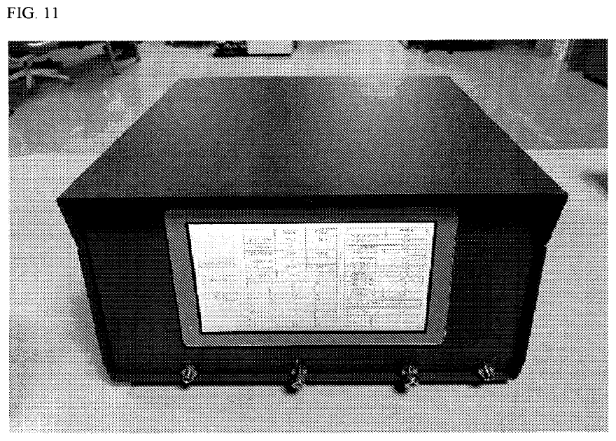

FIGS. 10 and 11 show the control box 60 that may be used in the present invention, and the control box 60 may include the LCD touch panel to display measurement results.

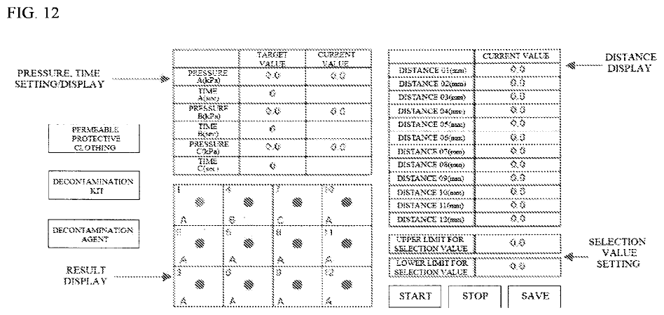

FIG. 12 shows a screen configuration of the control box 60, and the screen of the control box 60 may include sub display windows and buttons. Since the screen is formed of a touch panel, the user may manually touch the screen to start and stop the test, select the product type, input and set various values, and save setting values and result values.

### (1) Pressure and Time Setting and Display Window

The display window may be disposed at an upper left position of the screen and may display a test vessel number. A pressure and time value (a target value and present value) for each test product may be set and displayed on the screen.

### (2) Result Display Window

The display window may be disposed at a lower left position of the screen and may display, save, and output test result values for each product placed in the test vessel. In addition, the result values may each be displayed on one of a plurality of (e.g., 12) compartments, and passes or fails of products determined according to whether the corresponding products leak are displayed in different colors, making it easy to identify the test results for each product.

### (3) Distance Display Window

The display window may be disposed at a right position of the screen and may display values being measured by the distance measurement sensor 20. In addition, present distance measurement values may each be displayed on one of the plurality of (e.g., 12) compartments.

### (4) Selection Value Setting Window

The display window may be disposed at a lower right position of the screen, and a pressure required in a storage test procedure for each test product may be set through the display window. The user may input upper and lower limits for selection values for the distance by manually touch the screen.

### (5) Temperature and Humidity Measurement Result Display Window

The display window may be disposed at an appropriate position on the screen and may display each of measured temperature and humidity values. To this end, the testing device according to the present invention may further include a temperature sensor and a humidity sensor in the test vessel 10, the control box 60, etc. The display window may be omitted as needed.

### (6) Button

Buttons may be disposed at appropriate positions on the screen. For example, a start button, a stop button, and a save button may be disposed at a lower right portion of the screen and used to start, stop, and save the test, respectively. In addition, the product type may be selected after product type buttons are arranged at the left of the screen.

The characteristics of the test device according to the present invention will be described. First, the test device uses a difference in pressure and distance instead of using water, which is the method of the present (conventional) measurement device. Second, the test device is divided into the test vessel, the controller, and the vacuum pump to enable measurement and movement on site. Third, the test device may measure, for example, one permeable protective clothing c and 12 DS-2 decontamination agents or 12 decontamination kits per measurement and measure up to 3 samples with a large volume, such as the permeable protective clothing, by adding test vessels. Fourth, since one pressure sensor and 12 distance measurement sensors are provided, for example, for each test vessel, it is possible to check whether each of the 12 samples leaks. Fifth, the test device measures a change in distance depending on whether the sample leaks in a vacuum state, and when the distance is out of the reference distance, a failure is marked.

The test device according to the present invention is a packaging leakage test device for measuring a change in distance caused by expansion or shrinkage according to the presence or absence of leakage using, for example, one pressure sensor and 12 laser sensors (distance measurement sensors), is a mobile or portable test device that may perform measurement on site, may measure a single sample and a plurality of samples at the same time, check a failure for each sample when leakage occurs, and may be applied to any sealed packaged product including CBR materials, food products, and the like.

In addition, the present invention provides a method of testing packaging leakage using the above-described device for testing packaging leakage. The test method according to the present invention may include sealing the test vessel 10 after putting test target products (permeable protective clothings, decontamination agents, decontamination kits, and/or food products) into each compartment 14 of the test vessel 10, forming vacuum (negative pressure) in the test vessel 10 using the vacuum pump 40 and adjusting the vacuum level by operating the solenoid valve 50 based on the data measured by the pressure measurement sensor 30, and checking whether to leak by displaying the results measured by the distance measurement sensor 20 on the screen of the control box 60.

As described above, the distance measurement sensor 20 may measure the distance between the packaged product and the sensor 20, and for example, when the size or shape of the packaged product is changed depending on whether the packaged product leaks, the distance between the packaged product and the sensor 20 is changed, and thus it is possible to check whether the packaged product leaks by measuring the distance. For example, after the vacuum is generated in the test vessel 10, it is normal when the packaging swells, and it may be determined to be defective when the packaging maintains an original state. In addition, after the vacuum is released in the test vessel 10, it is normal when the packaging is restored to the original state, and it may be read to be defective when there is no change in the packaging.

The principle of the device for testing packaging leakage according to the present invention is to utilize the expansion characteristics in vacuum for products that have leaked and those that do not, and is an inspection method using the fact that the packaging material is a film type. Pressure equilibrium in different spaces in the sealed space (internal space of the packaging and external space of the packaging) is achieved. A volume of gas inside the packaging increases so that a pressure in the internal space of the sealed packaging achieves the pressure equilibrium with a pressure (vacuum/negative pressure) in the external space of the packaging (internal space of the test vessel 10). On the other hand, since the unsealed internal space of the packaging has the same pressure as the external space of the packaging, there is no change.

Describing briefly, taking advantage of the differences in expansion characteristics between leaked products and normal products in vacuum, it is possible to detect leaked products with a confidence level of 95% or a confidence level required by customers using significant statistical characteristics for each product. Those characteristics can be identified through the distance measurement sensor 20.

Specifically, when vacuum is formed inside the test vessel 10 (the set vacuum is maintained), it is normal when the packaging of the protective clothing swells, and it is defective when the packaging of the protective clothing maintains the original state. In addition, when there is no longer vacuum inside the test vessel 10 (no vacuum after a set time), it is normal when the packaging of the protective clothing is restored (shrunk) to the original state, and it is defective when there is no change in the packaging of the protective clothing.

According to the present invention, a leakage test, which is a major item in a reliability program for chemical materials stockpile equipment and materials that is performed every year, may be performed on site, thereby minimizing the number of visits to a military camp.

In addition, by identifying packaging damaged products due to training or the like by the direct use at the military camp and managing inventory, it is possible to serve to protect a human body in CBR warfare in the future.

In addition, the device for testing packaging leakage can be applied to food (film and can) products as well as CBR materials to identify products degenerated due to pinholes and can be applied to any product affected by packaging.

What is claimed is:

1. A device for testing packaging leakage, comprising:
a test vessel having a sealed internal space that accommodates a packaged product and having a plurality of compartments;
a distance measurement sensor configured to measure a distance to the packaged product;
a pressure measurement sensor configured to measure a pressure in the test vessel;
a vacuum pump configured to form vacuum in the internal space of the test vessel;
a solenoid valve configured to adjust a vacuum level of the test vessel; and
a control box interworked with the distance measurement sensor, the pressure measurement sensor, the vacuum pump, and the solenoid valve.

2. The device of claim 1, wherein the packaged product includes a chemical, biological, and radiological (CBR) protective clothing, decontamination agents, decontamination kits, or food products inside a film or can.

3. The device of claim 1, wherein the number of compartments is in a range of 5 to 20.

4. The device of claim 3, wherein the test vessel accommodates one chemical, biological, and radiological (CBR) protective clothing, 5 to 20 decontamination agents, 5 to 20 decontamination kits, or 5 to 20 food products.

5. The device of claim 1, wherein the test vessel includes an upper vessel and a lower vessel having the plurality of compartments.

6. The device of claim 5, wherein the upper vessel and the lower vessel are fastened using a locking device or fastened in a sliding manner.

7. The device of claim 1, wherein the distance measurement sensor is installed on an upper end of the test vessel in each compartment.

8. The device of claim 1, wherein the distance measurement sensor is a laser sensor and measures a change in distance depending on whether to leak in a vacuum state, and a failure is marked when the distance is out of a reference distance.

9. The device of claim 1, wherein one pressure measurement sensor is installed in the control box.

10. The device of claim 1, wherein the solenoid valve is operated based on data measured by the pressure measurement sensor, and a result measured by the distance measurement sensor is displayed on the control box.

11. The device of claim 1, wherein the control box includes a liquid crystal display (LCD) touch panel, and
a screen of the LCD touch panel includes at least one of:
(1) a pressure and time setting and display window through which a pressure and time value for each test product are set and displayed on the screen;
(2) a result display window which displays a test result value for each product placed in the test vessel;
(3) a distance display window which displays a value being measured by the distance measurement sensor;
(4) a selection value setting window through which a pressure required in a storage test procedure for each test product is set;
(5) a temperature and humidity measurement result display window; and
(6) a start button, a stop button, and a save button.

12. The device of claim 1, which is a mobile or portable test device that allows measurement to be performed on site, a single sample and a plurality of samples to be measured simultaneously, a failure of each of the samples to be checked when leakage occurs, and is applied to sealed packaged products including chemical, biological, and radiological (CBR) materials and food products.
